(19) United States
(12) Patent Application Publication
(10) Pub. No.: US 2016/0338886 A1
(43) Pub. Date: Nov. 24, 2016

(54) SAFETY HARNESS

(71) Applicant: Ferno-Washington, Inc., Wilmington, OH (US)

(72) Inventors: Timothy P. Schroeder, Mason, OH (US); Timothy R. Wells, Hillsboro, OH (US); David N. Fager, Columbus, OH (US)

(73) Assignee: FERNO-WASHINGTON, INC., Wilmington, OH (US)

(21) Appl. No.: 15/112,815

(22) PCT Filed: Feb. 10, 2015
(86) PCT No.: PCT/US2015/015165

§ 371 Date: Jul. 20, 2016

Related U.S. Application Data
(60) Provisional application No. 61/937,895, filed on Feb. 10, 2014.

(51) Int. Cl. A61G 1/044

(52) U.S. Cl. CPC A61G 1/044

(57) ABSTRACT

Patient harness systems (10) for an emergency cot (18) including a chest strap restraint (14), a thigh strap restraint (16), and a harness restraint (12) having a shoulder harness (20), a pelvis strap (22), and a pair of stabilizing straps (110). The harness restraint is mountable to the emergency cot via a plurality of quick release restraint buckles (54). Methods of securing a patient to the emergency cot using the patient harness system.

### CROSS REFERENCE TO RELATED APPLICATIONS

This application claims priority under 35 U.S.C. §119 to U.S. Provisional Patent Application No. 61/937,895, filed Feb. 10, 2014, entitled “Safety Harness” (Docket FER 0503 MA/40271.1012), the contents of which are hereby incorporated by reference in their entirety.

### TECHNICAL FIELD

The present disclosure relates generally to harnesses, and more specifically, to patient harness systems for emergency cots.

### BACKGROUND

Providing effective restraint for a patient in ambulances is a complex problem with many unique and unresolved issues. As the ambulance environment is specifically designed for emergency treatment of passengers, exposure in a crash environment may be more severe to a patient requiring transport. When transporting a patient with an acute medical problem that requires constant monitoring, a current practice is to restrain the patient directly to the cot with chest and hip belts. Another practice in transporting patients is to employ patient harness systems for emergency cots for restraining the patient. However, improvements to such practices are needed, e.g., providing crash restraint by minimizing general patient movement.

### SUMMARY

It is against this background that the present disclosure provides patient harness systems for emergency cots which provide crash restraint by minimizing general patient movement.

In one embodiment, a patient harness system for an emergency cot is disclosed. The patient harness system may include a chest strap restraint, a thigh strap restraint, and a harness restraint. The harness restraint may include a shoulder harness, a pelvis strap attachable to the shoulder harness, and a pair of stabilizing straps attached to the pelvis strap. The harness restraint may be mountable to the emergency cot via a plurality of quick release restraint buckles. Each of the quick release restraint buckles may include a mounting point or a slot. The mounting point may include a stem portion attached to a cap portion. The slot may include an upper slot section, a lower slot section, and a pair of detents. The upper slot section and the lower slot section may be separated by the pair of detents. The upper slot section may taper to the pair of detents. The detents may be sized to snap fit a mounting point provided to the emergency cot from the upper slot section to the lower slot section. The shoulder harness may include a pair of shoulder strap segments attached to a securing strap, wherein the securing strap segment includes a first pair of the quick release restraint buckles. The pelvis strap may include a second pair of the quick release restraint buckles. The pair of stabilizing straps may include a third pair of the quick release restraint buckles.

In another embodiment, a patient harness system for an emergency cot is disclosed. The patient harness system may include a chest strap restraint, a thigh strap restraint, and a harness restraint. The harness restraint may include a shoulder harness, a pelvis strap attachable to the shoulder harness, and a pair of stabilizing straps attached to the pelvis strap. The harness restraint may be mountable to the emergency cot via a plurality of quick release restraint buckles. Each of the quick release restraint buckles may include a mounting point or a slot. The mounting point may include a stem portion attached to a cap portion. The slot may include an upper slot section, a lower slot section, and a pair of detents. The upper slot section and the lower slot section may be separated by the pair of detents. The upper slot section may taper to the pair of detents. The detents may be sized to snap fit a mounting point provided to the emergency cot from the upper slot section to the lower slot section. The shoulder harness may include a pair of shoulder strap segments attached to a securing strap, wherein the securing strap segment includes a first pair of the quick release restraint buckles. The pair of shoulder strap segments may also provide a pair of tangs each with a slot. The pelvis strap may include a second pair of the quick release restraint buckles. The pair of stabilizing straps may include a third pair of the quick release restraint buckles.

In yet another embodiment, a method of securing a patient to an emergency cot using a patient harness system is provided. In this embodiment, the method includes securing a chest strap restraint to the emergency cot, securing a thigh strap restraint to the emergency cot, and mounting a harness restraint to the emergency cot via a plurality of quick release restraint buckles. The harness restraint may include a shoulder harness, a pelvis strap attachable to the shoulder harness, and a pair of stabilizing straps attached to the shoulder harness or the pelvis strap. The harness restraint may be mountable to the emergency cot via a plurality of quick release restraint buckles. The shoulder harness may include a pair of shoulder strap segments attached to a securing strap segment, the securing strap segment providing a first pair of quick release restraint buckles. The pelvis strap may provide a second pair of quick release restraint buckles, and the pair of stabilizing straps may provide a third pair of quick release restraint buckles.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a front elevated perspective view of an embodiment of a patient restraint system with a pair of stabilizing straps according to an embodiment of the present disclosure, and shown provided to an emergency cot with a portion looping around a mattress with a fitted sheet thereof and prepared for use;

FIG. 2 is a front elevated perspective view of an embodiment of a patient restraint system with a plurality of pairs of stabilizing straps according to an embodiment of the present disclosure, and shown provided to an emergency cot with a portion looping around a mattress with a fitted sheet thereof and prepared for use;

FIG. 3 is a front elevated perspective view of an embodiment of a patient restraint system with a pair of stabilizing straps according to the present disclosure securing a patient to an emergency cot;

FIG. 4 is a front perspective view of an embodiment of a harness restraint provided with a chest strap according to the present disclosure;

FIG. 5 is a side elevated perspective view of an embodiment showing the attaching of a chest strap restraint of the patient restraint system through a backrest panel of an emergency cot;

FIG. 6 is a bottom perspective view of an embodiment showing the threading of a thigh strap restraint of the patient restraint system through a seat panel of an emergency cot;

FIG. 7 is a side elevated, partial perspective view of an embodiment showing fitting of a pelvis strap of the patient restraint system on an emergency cot;

FIG. 8 is a side elevated, partial perspective view of an embodiment showing fitting of a quick release restraint buckle of the patient restraint system to an emergency cot;

FIG. 9 is a side elevated, partial perspective view of an embodiment showing fitting of a retaining plug of a quick release restraint buckle provided by the securing strap of the patient restraint system;

FIG. 10 is a side elevated, partial perspective view of an embodiment of the retaining plug of FIG. 9 properly fitted in place;

FIG. 11 is a side elevated, partial perspective view of an embodiment showing fitting of a retaining plug of a quick release restraint buckle provided by a first pair of stabilizing straps of the patient harness system to an emergency cot;

FIG. 12 is a side elevated, partial perspective view of an embodiment showing fitting of quick release restraint buckles of the patient restraint system to an emergency cot provided by a securing strap segment and a third pair of stabilizing straps of the patient harness system;

FIG. 13 is a front partial perspective view of an embodiment showing the feeding of a tang of a pelvis strap of the patient harness system through slots of tangs of a shoulder harness of the patent harness system according to the present disclosure;

FIG. 14 is a side elevated, partial perspective view of an embodiment showing a quick release restraint buckle with a locking tab of the patient restraint system to an emergency cot;

FIG. 15 is a side elevated, partial perspective view of an embodiment showing a locking tab of a quick release restraint buckle provided by a first pair of stabilizing straps of the patient harness system to an emergency cot; and

FIG. 16 is a side elevated, partial perspective view of an embodiment showing a quick release restraint buckle of the patient restraint system to an emergency cot.

Skilled artisans appreciate that elements in the figures are illustrated for simplicity and clarity and are not necessarily drawn to scale. For example, the dimensions of some of the elements in the figures may be exaggerated relative to other elements, as well as conventional parts removed, to help to improve understanding of the various embodiments of the present disclosure.

### DETAILED DESCRIPTION

Reference will now be made in detail to embodiments of a patient harness system. In one or more embodiments, the patient harness system includes a chest strap restraint, a thigh strap restraint, and a harness restraint. The harness restraint may include a shoulder harness, a pelvis strap attachable to the shoulder harness, and at least one pair of stabilizing straps attached to the pelvis strap.

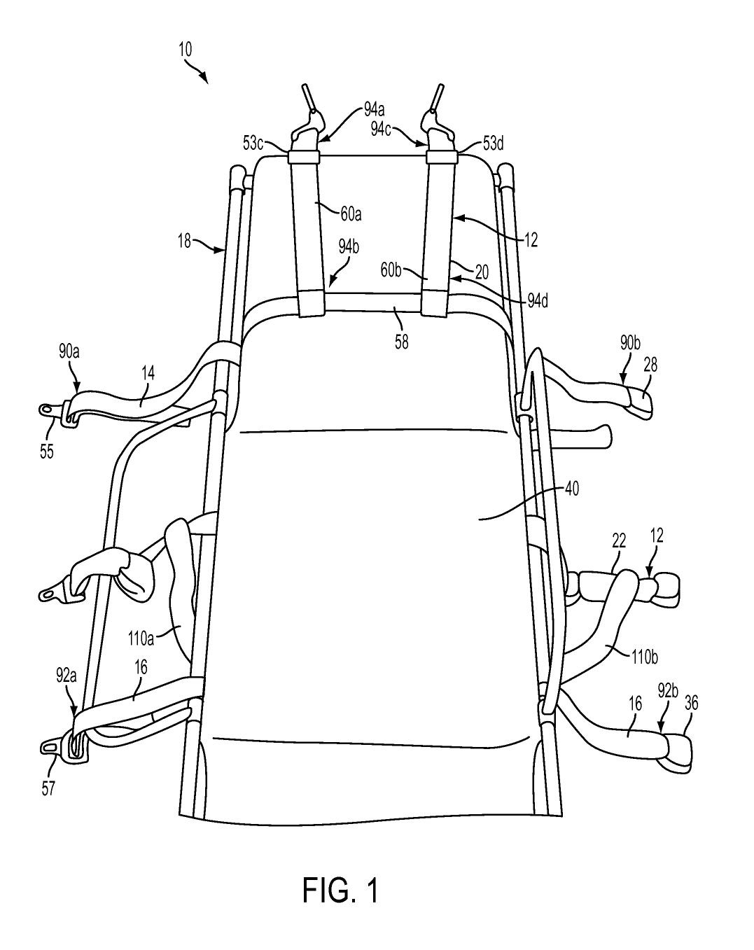

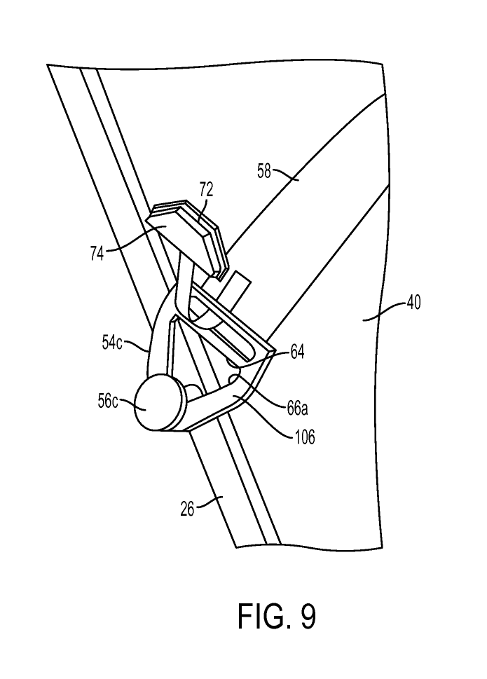

Embodiments of the patient harness system will be described now with reference to FIGS. 1-16. Thereafter, embodiments of use of the patient harness system will be described with reference to FIGS. 1-16.

### Patient Harness Systems

According to the present disclosure, in one or more embodiments, such as depicted by FIGS. 1-3, a patient harness system 10 having a harness restraint 12, a chest strap restraint 14, and a thigh strap restraint 16 is disclosed. In embodiments, each of the chest and thigh strap restraints 14 and 16 includes respective end portions thereof, 90a and 90b, and 92a and 92b, respectively. One end portion, 90b and 92b, of both the chest and thigh strap restraints 14 and 16 may provide a buckle, 28 and 36, respectively. The remaining end portion, 90a and 92a, of both the chest and thigh strap restraints 14 and 16 may provide a tang, 55 and 57, respectively. Each of the tangs 55 and 57 may be sized to fit through respective slots of each of the buckles 28 and 36, wherein they may also be seated releasably.

With regard to the harness restraint 12, such as depicted by FIGS. 1-3, in one or more embodiments, the harness restraint 12 has at least three parts: (1) the shoulder harness 20; (2) the pelvis strap 22; and (3) at least one pair of stabilizing straps 110a and 110b (hereinafter, “the first pair of stabilizing straps”). In one or more embodiments, the harness restraint 12 is mountable to the emergency cot 18 via a plurality of quick release restraint buckles 54a, 54b, 54c, 54d, 54e, and 54f.

With regard to the shoulder harness 20, as shown in FIGS. 1, 2, and 4, in one or more embodiments, the shoulder harness 20 has a pair of shoulder strap segments 60a and 60b attached to a securing strap segment 58. In some embodiments, each of the pair of shoulder strap segments 60a and 60b and the securing strap segment 58 includes respective end portions thereof 94a and 94b, 94c and 94d, and 96a and 96b, respectively. The securing strap segment 58 may provide a pair, 54c and 54d, of the plurality of quick release restraint buckles (hereinafter, “the first pair of quick release restraint buckles”). More particularly, the securing strap segment 58 may provide one buckle 54c of the first pair of quick release restraint buckles, 54c and 54d, at one end portion thereof 96a and a second buckle 54d of the first pair of quick release restraint buckles, 54c and 54d, at the remaining end portion 96b thereof.

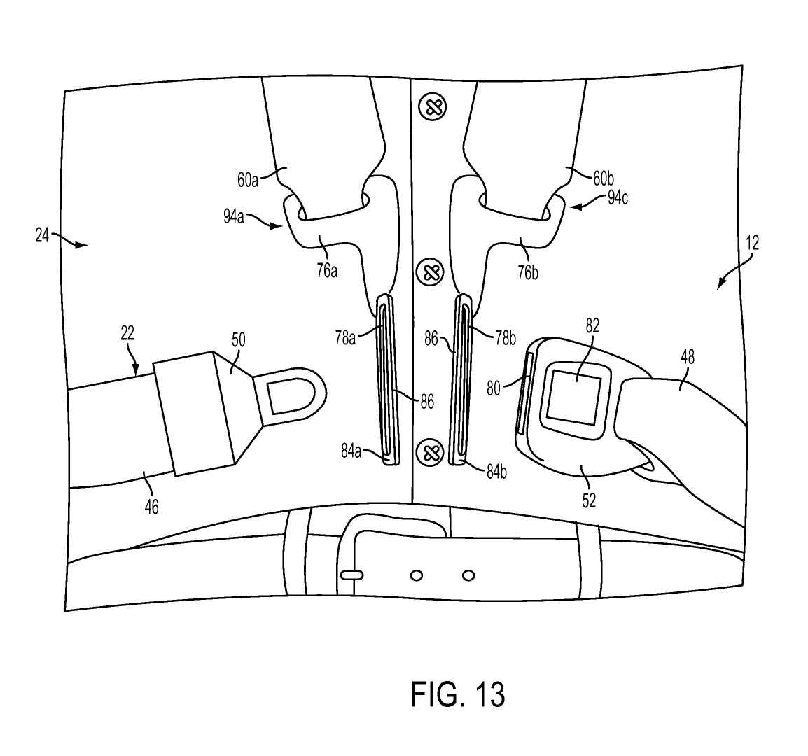

In one or more embodiments, such as is shown in FIGS. 1, 4, and 13, the shoulder strap segments 60a and 60b provide a pair of tangs, 76a and 76b. In embodiments, the pair of tangs, 76a, 76b, are elongate and/or twisted. More particularly, in embodiments, each of the shoulder strap segments, 60a and 60b, provides one of the pair of tangs, 76a and 76b, at a respective end portion thereof, 94a and 94c. In further embodiments, each of the shoulder strap segments, 60a and 60b, provides one of the pair of elongate and/or twisted tangs, 76a and 76b, at a respective end portion thereof, 94a and 94c. Each of the pair of tangs, 76a and 76b, may provide an aperture or slot therein, 78a and 78b, such as, e.g., an elongate aperture or slot, respectively, such as is shown in FIG. 13. In further embodiments, each of the pair of tangs, 76a and 76b, includes a continuous surface 86, such as, e.g., a continuous outer surface 86, which defines an aperture or slot, 78a and 78b, therein. More particularly, in some embodiments, each of the pair of tangs, 76a and 76b, includes a continuous surface 86 which surrounds the aperture or slot, 78a and 78b, defined therein.

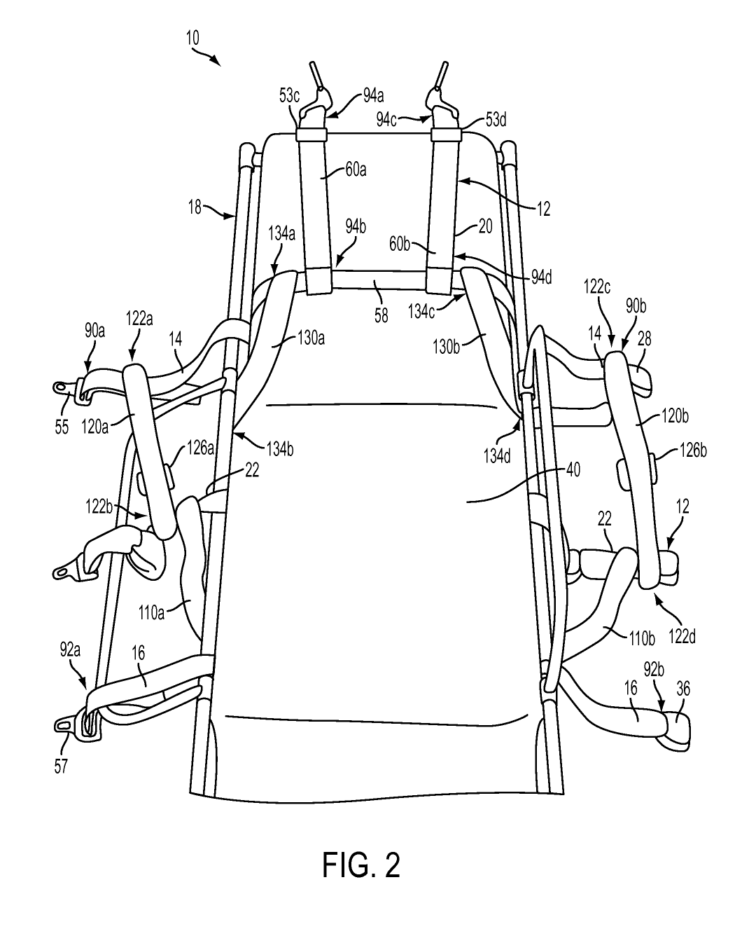

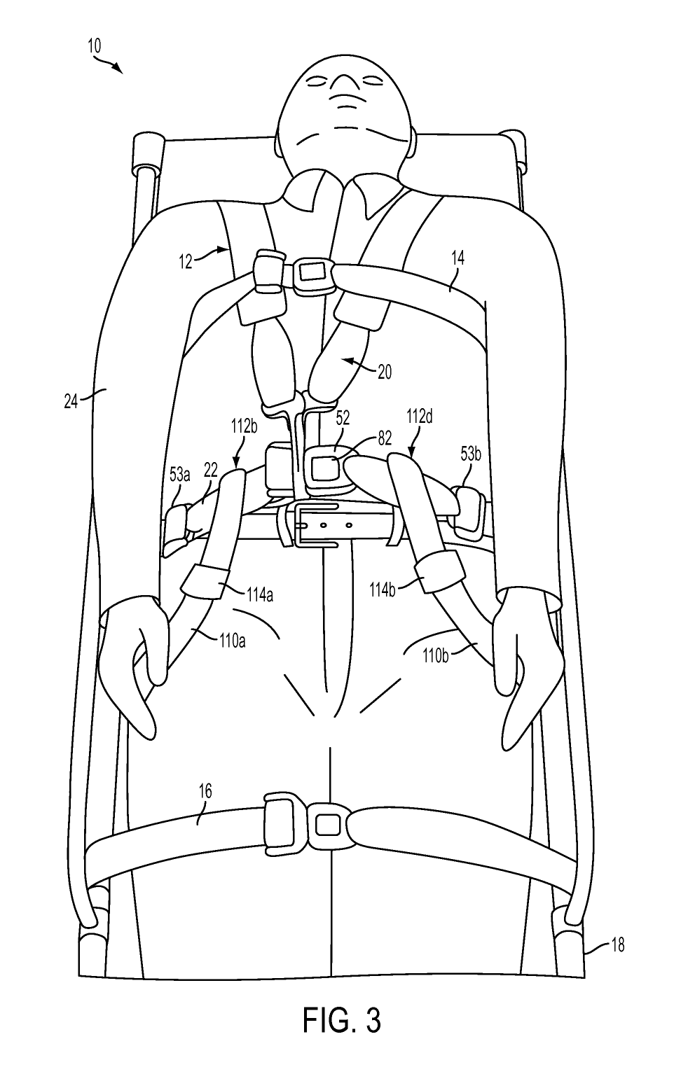

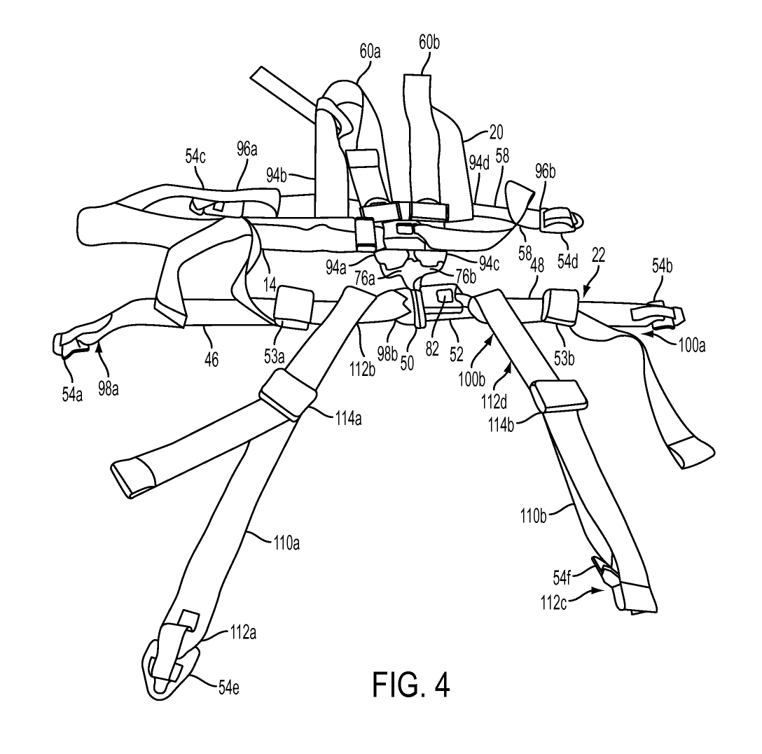

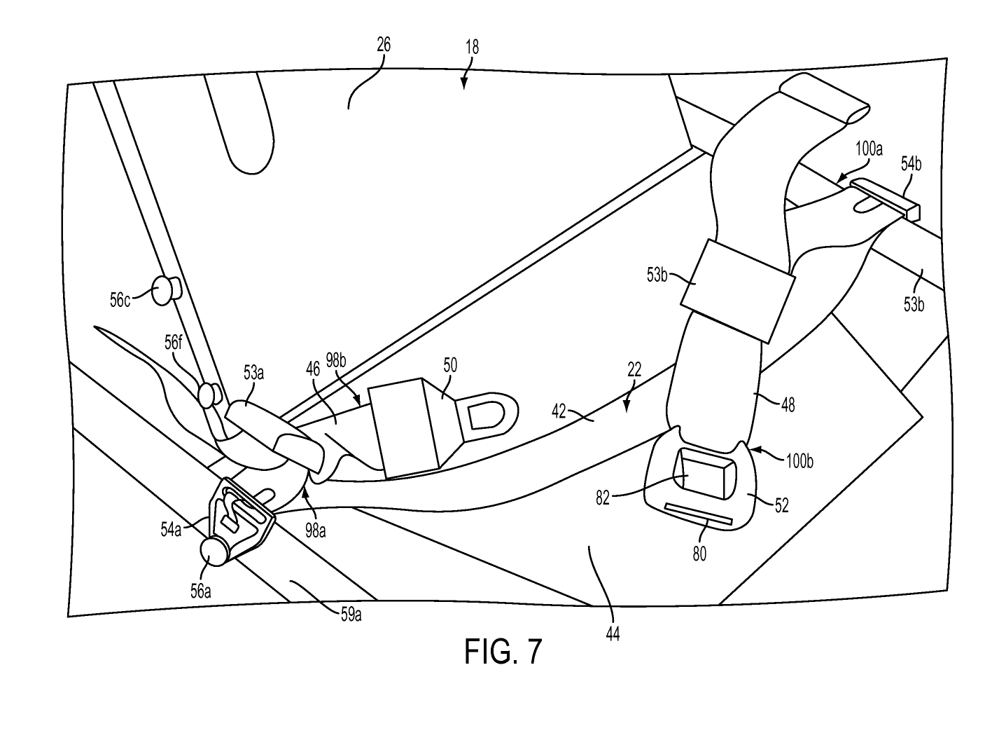

With regard to the pelvis strap 22, referencing FIGS. 4 and 7, in one or more embodiments, the pelvis strap 22 has a first pelvis strap segment 42, a second pelvis strap segment 46, and a third pelvis strap segment 48. In some embodiments, the second pelvis strap segment 46 and the third pelvis strap segment 48 are attachable to, attached to, and/or integral with the first pelvis strap segment 42. Strap length adjusters, 53a and 53b, may be provided to the second and/or third pelvis strap segments, 46 and 48, respectively. Additionally, the second and third pelvis strap segments, 46 and 48, may each have respective end portions thereof, 98a and 98b, and 100a and 100b, respectively. One of the end portions, 98b and 100b, of each of the second and third pelvis strap segments 46 and 48 may respectively provide a tang 50 and a buckle 52. The tang 50 may be sized to fit through an engagement slot 80 of the buckle 52 and to be seated releasably therein, such that when joined together, the tang 50 and the buckle 52 may be positioned on top of the patient 24 (such as is shown by FIG. 3). Moreover, the tang 50 may be sized to fit through each aperture or slot, 78a and 78b, of the tangs, 76a and 76b. In this embodiment, the tangs, 76a and 76b, are sized to permit the tang 50 of the pelvis strap 22 to fit therethrough and to be seated releasably in the engagement slot 80 of the buckle 52. In this way, the harness restraint 12 may remain securely positioned, such as, e.g., centered, on a particular part of the patient 24 when secured thereto (such as is described in greater detail below). Additionally, a push button 82 on the buckle 52 may be operated to release the tang 50 therefrom, which is the same for tangs 55 and 57 and buckles 28 and 36 respectively provided on the end portions, 90a and 90b, and 92a and 92b, of the chest and thigh strap restraints 14 and 16, respectively (FIGS. 1-2).

Referring again to FIGS. 4 and 7, in one or more embodiments, the pelvis strap 22 provides a pair, 54a and 54b, of the plurality of quick release restraint buckles (hereinafter, “the second pair of quick release restraint buckles”). More specifically, one of the respective end portions 98a and 100a of each of the second and third pelvis strap segments 46 and 48 may provide one of the second pair of quick release restraint buckles 54a and 54b. In some embodiments, the second pair of quick release restraint buckles 54a and 54b is respectively positioned between the first and second pelvis strap segments, 42 and 46, and the first and third pelvis strap segments, 42 and 48.

With regard to the first pair of stabilizing straps, 110a and 110b, as shown in FIGS. 1-4, each of the first pair of stabilizing strap segments, 110a and 110b, may have respective end portions thereof, 112a and 112b, and 112c and 112d. In some embodiments, the first pair of stabilizing straps, 110a and 110b, are attachable to, attached to, and/or integral with the pelvis strap 22. More particularly, each of the first pair of stabilizing straps 110a and 110b may be respectively attachable to, attached to, and/or integral with the second pelvis strap segment 46 and the third pelvis strap segment 48. In a further embodiment, one end portion, 112b and 112d, of each of the first pair of stabilizing straps 110a and 110b is attachable to, attached to, and/or integral with the second pelvis strap segment 46 and the third pelvis strap segment 48. In one or more embodiments, each of the first pair of stabilizing straps, 110a and 110b, may be fixedly attached to the second pelvis strap segment 46 and the third pelvis strap segment 48.

As shown in FIG. 4, in one or more embodiments, the first pair of stabilizing straps 110a and 110b provides a pair, 54e and 54f, of the plurality of quick release restraint buckles (hereinafter, “the third pair of quick release restraint buckles”). More particularly, one end portion, 112a and 112c, of each of the first pair of stabilizing strap segments 110a and 110b respectively provides one of the third pair of quick release restraint buckles, 54e and 54f. Strap length adjusters 114a, 114b may also be provided to one and/or both of the first pair of stabilizing straps 110a and 110b.

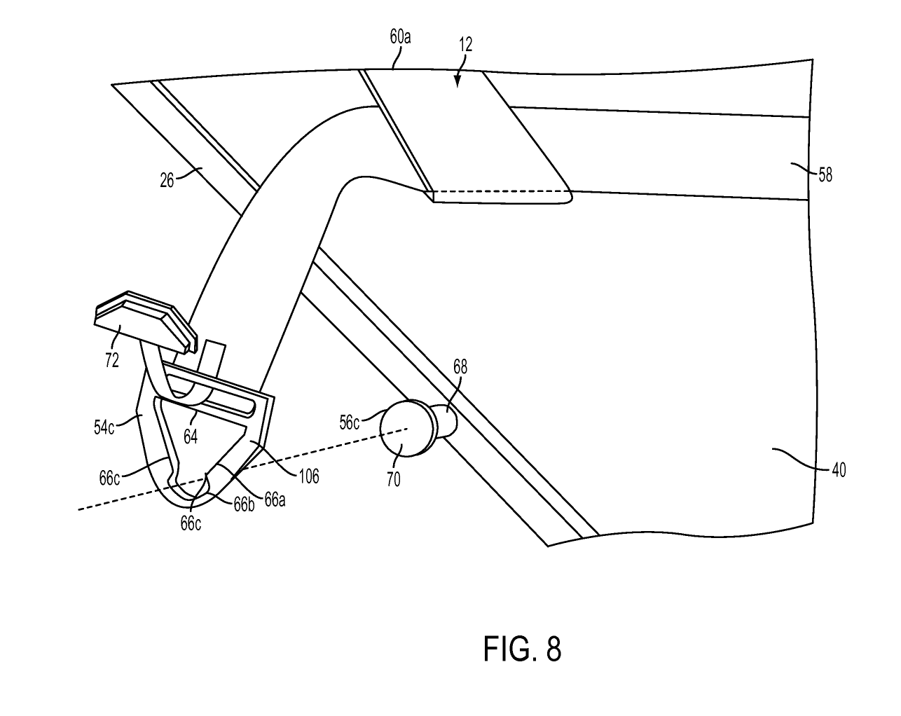

With regard to the plurality of quick release restraint buckles 54a, 54b, 54c, 54d, 54e, 54f, and/or 54g (e.g., the first, second, third, and/or fourth pair of quick release restraint buckles (discussed below)), referencing FIGS. 8-12, in one or more embodiments, each of the plurality of quick release restraint buckles provides an aperture or slot 64 with an upper slot section 66a which tapers down to a lower slot section 66b. In some embodiments, the aperture or slot 64 is keyhole shaped. In embodiments, each of the plurality of quick release restraint buckles includes a continuous surface 106, such as, e.g., a continuous outer surface 106, which defines the aperture or slot 64 therein. More particularly, in some embodiments, each of the plurality of quick release restraint buckles includes a continuous outer surface 106 which surrounds the aperture or slot 64, such as, e.g., the keyhole shaped aperture or slot 64, defined therein.

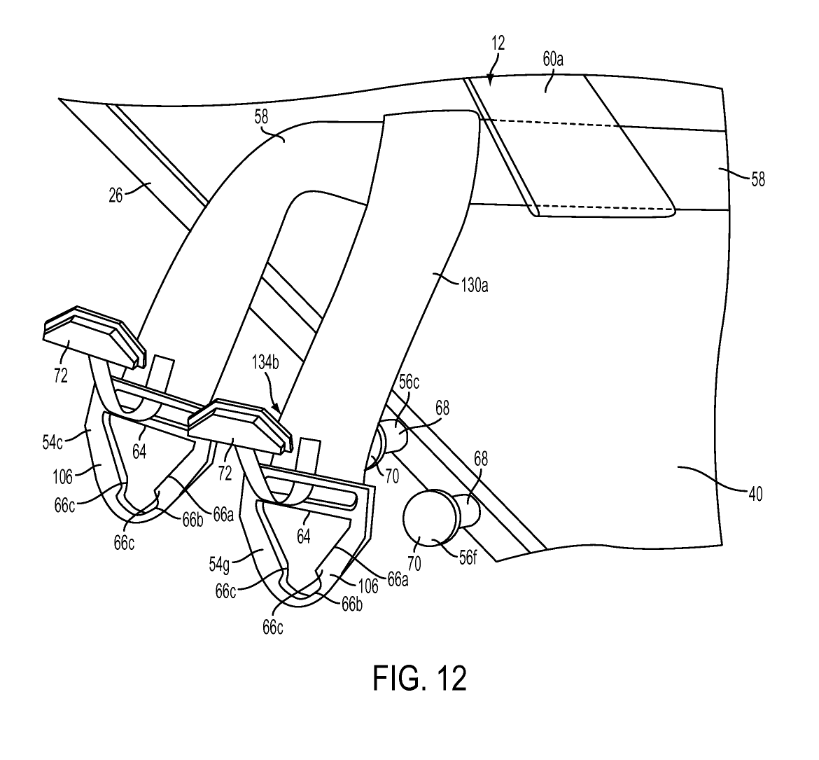

In some embodiments, the upper slot section 66a and the lower slot section 66b are separated by the pair of detents 66c. In some embodiments, the pair of detents 66c are in between the upper slot section 66a and the lower slot section 66b. In embodiments, the upper slot section 66a tapers to the pair of detents 66c. The pair of detents 66c may be sized to snap fit a mounting point provided to the emergency cot 18 from the upper slot section 66a to the lower slot section 66b. Each of the respective mounting points 56a, 56b, 56c, 56d, 56e and/or 56f may include a stem portion 68 and a cap portion 70, such as is shown in FIGS. 8 and 12. The stem portion 68 is attachable to, attached to, and/or integral with the cap portion 70. Referencing FIG. 8, in one or more embodiments, the cap portion 70 is wider than the lower slot section 66b, ensuring that the quick release restraint buckle 54c cannot slip off the mounting point 56c. Additionally, the pair of detents 66c may be slightly narrower than the diameter of the stem portion 68 of each of the respective mounting points 56a, 56b, 56c, 56d, 56e, 56f, and/or 56g. In some embodiments, due to the narrower detent section 66c, positioning the stem portion 68 in the upper slot section 66a and pulling upwards on the quick release restraint buckle 54c will snap fit the stem portion 68 past the detent section 66c and be retained via an interference fit with the detent section 66c in the lower slot section 66b. The snap fit employed by the quick release restraint buckles, according to the present disclosure, may permit quick releasing of the buckles 54a, 54b, 54c, 54d, 54e, 54f, and/or 54g without the use of a tool.

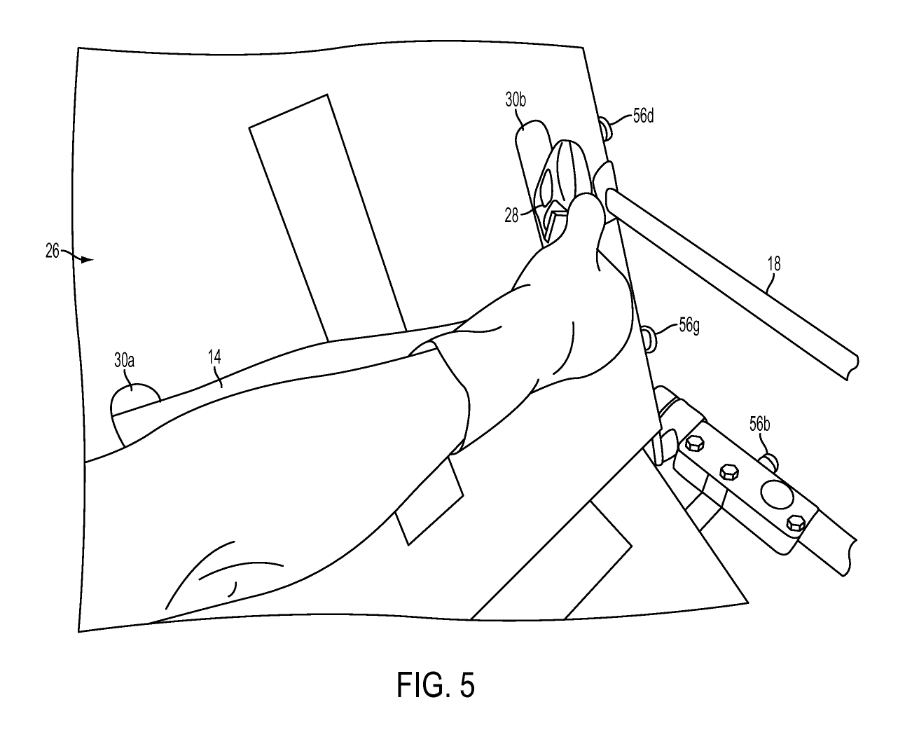

In one or more embodiments, referencing FIGS. 5 and 8-12, the emergency cot 18 provides a plurality of mounting points 56a, 56b, 56c, 56d, 56e, 56f, and/or 56g for the plurality of quick release restraint buckles 54a, 54b, 54c, 54d, 54e, 54f, and/or 54g (e.g., the first, second, third, and/or fourth pair of quick release restraint buckles (discussed below)). In further embodiments, each of the securing strap segment 58, the pelvis strap 22, and the first pair of stabilizing straps 110a and 110b mount releasably to the plurality of mounting points 56a, 56b, 56c, 56d, and/or 56e, via the first, second, and/or third pair of quick release restraint buckles 54c and 54d, 54a and 54b, and/or 54e and 54f, respectively.

In one or more embodiments, with specific reference to FIGS. 5 and 8-10, the mounting points, 56c and 56d, for the securing strap segment 58 (i.e., “the first pair of mounting points”) are provided on lateral sides of the backrest panel 26 of the emergency cot 18 (such as is shown in FIG. 8). In other embodiments, the first pair of mounting points, 56c and 56d, are located at any place on the emergency cot 18 that is convenient in securing the first pair of quick release restraint buckles, 54c and 54d, to the emergency cot 18 such that they provide suitable use of the securing strap segment 58 to the respective mounting points, 56c and 56d. In other embodiments, the first pair of mounting points, 56c and 56d, are located at any place on the cot 18 that is convenient in securing the first pair of quick release restraint buckles, 54c and 54d, to the cot 18 such that they provide suitable use of the securing strap segment 58 as shown by FIG. 3.

In one or more embodiments, with specific reference to FIGS. 5 and 7, the mounting points, 56a and 56b, for the pelvis strap 22 (i.e., “the second pair of mounting points”) are provided on side longitudinally extending frame members 59a and 59b adjacent the seat panel 44. In other embodiments, the second pair of mounting points, 56a and 56b, are located at any place on the cot 18 that is convenient in securing the second pair of quick release restraint buckles, 54a and 54b, to the cot 18 such that they still provide suitable use of the pelvis strap 22 to the respective mounting points, 56a and 56b, such as is shown by FIG. 3.

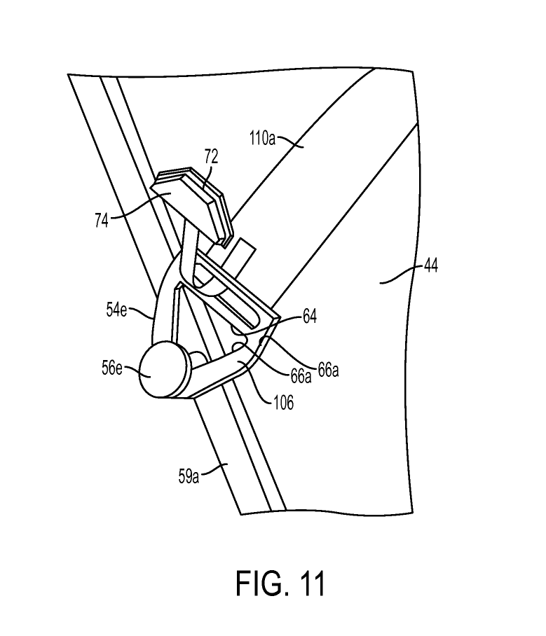

In one or more embodiments, referring to FIG. 11, the mounting points, 56e and remaining mounting point (not shown), for the first pair of stabilizing straps 110a and 110b (i.e., “the third pair of mounting points”) are respectively provided on side longitudinally extending frame members, 59a and 59b, adjacent the seat panel 44. In other embodiments, the third pair of mounting points, 56e and the remaining mounting point (not shown), are located at any place on the cot 18 that is convenient in securing the third pair of quick release restraint buckles, 54e and 54f, to the cot 18 such that they still provide suitable use of the first pair of stabilizing straps 110a and 110b to the respective mounting points, 56e and the remaining mounting point (not shown), such as is shown by FIG. 3. While not shown, the remaining mounting point of the third pair of mounting points is identical to the mounting point 56e, provided on an opposing side longitudinally extending frame member, 59a or 59b, adjacent the seat panel 44.

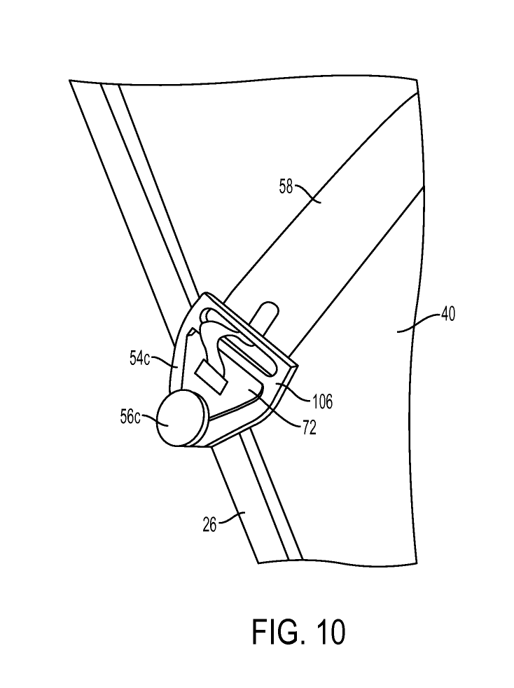

Referencing FIGS. 8-12, although the harness restraint 12 is designed to be easily removed without the use of a tool to allow quick patient transfer, in one or more embodiments, the harness restraint 12 further provides a retaining plug 72 to each of the plurality of quick release restraint buckles 54a, 54b, 54c, 54d, 54e, 54f, and/or 54g (e.g., to each of the first, second, third, and/or fourth pair (discussed below) of quick release restraint buckles) to avoid an unintentional release. In some embodiments, the retaining plug 72 has a plug portion 74 sized to fit securely in the upper slot section 66a of the plurality of quick release restraint buckles 54a, 54b, 54c, 54d, 54e, 54f, and/or 54g. In other embodiments, the retaining plug 72 has a plug portion 74 shaped to fit tightly in the upper slot section 66a of the plurality of quick release restraint buckles 54a, 54b, 54c, 54d, 54e, 54f, and/or 54g. The plug portion 74 may correspond in size and/or shape to the upper slot section 66a of the plurality of quick release restraint buckles 54a, 54b, 54c, 54d, 54e, 54f, and/or 54g such that it fits securely therein. With specific reference to FIG. 10, with the plug portion 74 pushed into the upper slot section 66a, the retaining plug 72 prevents an unintentional downward pull on the restraint buckle 54c from quick releasing the stem portion 68 of the mounting points 56c and 56f from the lower slot section 66b.

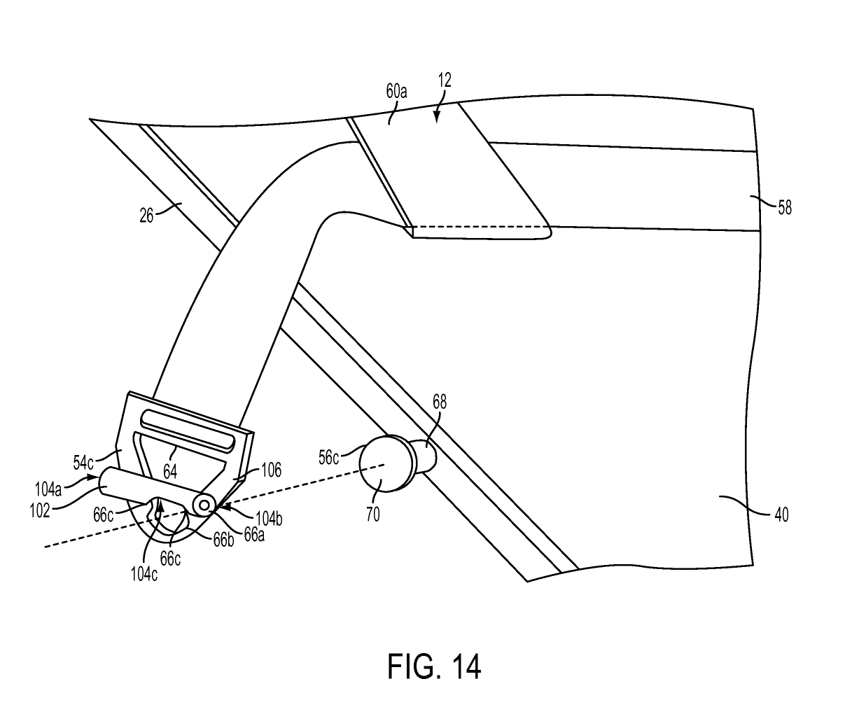

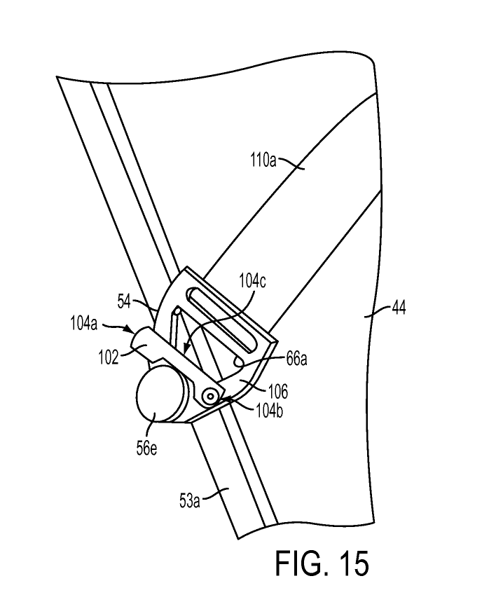

Referencing FIGS. 14-15, although the harness restraint 12 is designed to be easily removed without the use of a tool to allow quick patient transfer, in some embodiments, the harness restraint 12 further provides a locking tab 102 attached to and/or attachable to each of the plurality of quick release restraint buckles 54a, 54b, 54c, 54d, 54e, 54f, and/or 54g (e.g., to each of the first, second, third, and/or fourth pair (discussed below) of quick release restraint buckles) to avoid an unintentional release. In one or more embodiments, the locking tab 102 is elongate in shape and has an attachment end portion 104b, a free end portion 104a, and a locking portion 104c. The locking portion 104c is integral with and/or attached to both the attachment end portion 104b and the free end portion 104a. In embodiments, the locking portion 104c is narrower in width than the attachment end portion 104b and/or the free end portion 104a. In embodiments, the locking portion 104c is shaped to accommodate the mounting points 56a, 56b, 56c, 56d, 56e, 56f, and/or 56g, such as, e.g., the stem portion 68 and/or a cap portion 70 thereof. In some embodiments, the attachment end portion 104b is attached to and/or attachable to one of the plurality of quick release restraint buckles 54a, 54b, 54c, 54d, 54e, 54f, and/or 54g. In further embodiments, the attachment end portion 104b is attached to and/or attachable to an outer surface 106 of one of the plurality of quick release restraint buckles 54a, 54b, 54c, 54d, 54e, 54f, and/or 54g. In some embodiments, the locking tab 102 is elongate in shape and extends length-wise across the slot 64, such as, e.g., the keyhole shaped slot 64, of the quick release restraint buckle to which it is attached. In further embodiments, the locking tab 102 is elongate in shape and extends length-wise across the upper slot section 66a of the quick release restraint buckle to which it is attached.

In one or more embodiments, the locking tab 102 is biased, such as, e.g., spring-biased, toward a locking position thereof. In this way, extension of the locking tab 102 across the slot 64 may prevent an unintentional downward pull on any of the quick release restraint buckles 54a, 54b, 54c, 54d, 54e, 54f, and/or 54g from quick releasing the stem portion 68 of the mounting points from the lower slot sections 66b thereof, when attached thereto. In some embodiments, the locking tab 102 may be formed from a flexible material, such as, e.g., metal and/or plastics, which may allow the locking tab 102 to translate toward and away from the outer surface 106 of the quick release restraint buckle to which it is attached. Such translation of the locking tab 102 may aid in attaching and/or unattaching a quick release restraint buckle to its corresponding mounting point.

The plurality of quick release restraint buckles 54a, 54b, 54c, 54d, 54e, 54f, and/or 54g may include locking tabs 102, retaining plugs 72, or a combination thereof. For example, each of the plurality of quick release restraint buckles 54a, 54b, 54c, 54d, 54e, 54f, and/or 54g may include a locking tab 102. Alternatively, each of the plurality of quick release restraint buckles 54a, 54b, 54c, 54d, 54e, 54f, and/or 54g may include a retaining plug 72. Finally, some of the plurality of quick release restraint buckles 54a, 54b, 54c, 54d, 54e, 54f, and/or 54g may include a locking tab 102 and some of the plurality of quick release restraint buckles 54a, 54b, 54c, 54d, 54e, 54f, and/or 54g may include a retaining plug 72.

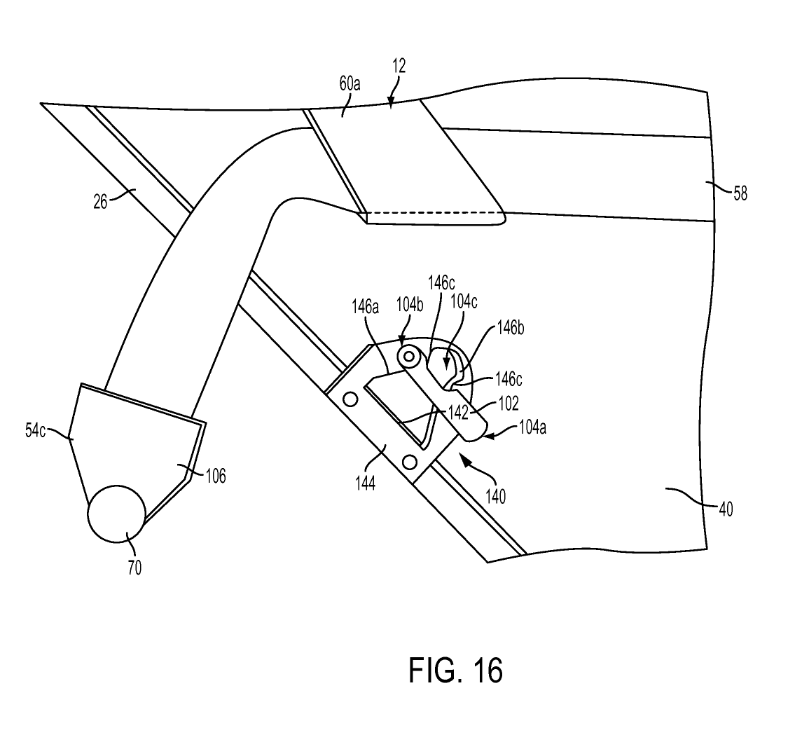

Referring now to FIG. 16, in alternative embodiments, the plurality of mounting points 56a, 56b, 56c, 56d, 56e, 56f, and/or 56g (as previously described and described below, including a stem portion 68 and/or a cap portion 70 thereof) are respectively provided on the plurality of quick release restraint buckles 54a, 54b, 54c, 54d, 54e, 54f, and/or 54g. In this embodiment, the plurality of quick release restraint buckles 54a, 54b, 54c, 54d, 54e, 54f, and/or 54g may include a solid continuous surface 106 and/or may not include apertures or slots defined therein. In further embodiments, mounting structures 140 having apertures or slots 142, such as, e.g., keyhole shaped apertures or slots 142, for each of the plurality of quick release restraint buckles 54a, 54b, 54c, 54d, 54e, 54f, and/or 54g having mounting points 56a, 56b, 56c, 56d, 56e, 56f, and/or 56g (as previously described) are provided by the emergency cot 18. The apertures or slots 142 are as previously described with regard to the apertures or slots 64 provided by the plurality of quick release restraint buckles. For example, the apertures or slots 142 may be keyhole shaped, and may include an upper slot section 146a, a lower slot section 146b, and a pair of detents 146c. In embodiments, each of the mounting structures 140 includes a continuous surface 144, such as, e.g., a continuous outer surface 144, which defines the aperture or slot 142 therein. More particularly, in some embodiments, each of the mounting structures 140 includes a continuous outer surface 144 which surrounds the aperture or slot 142 defined therein.

More particularly, mounting structures 140 having apertures or slots 142, such as, e.g., keyhole shaped slots 142, for each of the plurality of quick release restraint buckles 54a, 54b, 54c, 54d, 54e, 54f, and/or 54g may be provided by the emergency cot 18 at any suitable positions thereon, such as, e.g., on frame members 59a, 59b, on the backrest panel 26, and/or on the leg panels 32. The mounting structures 140 having apertures or slots 142 may be integral with, attached to, and/or attachable to the emergency cot 18. Where the mounting structures 140 having apertures or slots 142 are attached to and/or attachable to the emergency cot 18, the mounting structures 140 may be provided as separate mounting structures 140 which may be bolted to and/or otherwise attached to the emergency cot 18. In still further embodiments, locking tabs 102 extend across each of the keyhole shaped apertures or slots 142. The locking tabs 102 are as previously described. In these embodiments, each of the plurality of quick release restraint buckles mount to their respective apertures or slots 142 by pulling upwards on each of the quick release restraint buckles to snap fit the stem portion 68 of the mounting points 56a, 56b, 56c, 56d, 56e, 56f, and/or 56g past the detent section 146c of the keyhole shaped aperture or slot 142.

The plurality of quick release restraint buckles 54a, 54b, 54c, 54d, 54e, 54f, and/or 54g may include locking tabs 102, retaining plugs 72, mounting points 56a, 56b, 56c, 56d, 56e, 56f, and/or 56g, or a combination thereof. For example, each of the plurality of quick release restraint buckles 54a, 54b, 54c, 54d, 54e, 54f, and/or 54g may include a locking tab 102. Alternatively, each of the plurality of quick release restraint buckles 54a, 54b, 54c, 54d, 54e, 54f, and/or 54g may include a retaining plug 72. Alternatively, each of the plurality of quick release restraint buckles 54a, 54b, 54c, 54d, 54e, 54f, and/or 54g may include a mounting point 56a, 56b, 56c, 56d, 56e, 56f, and/or 56g. Finally, some of the plurality of quick release restraint buckles 54a, 54b, 54c, 54d, 54e, 54f, and/or 54g may include a locking tab 102, some of the plurality of quick release restraint buckles 54a, 54b, 54c, 54d, 54e, 54f, and/or 54g may include a retaining plug 72, and/or some of the plurality of quick release restraint buckles 54a, 54b, 54c, 54d, 54e, 54f, and/or 54g may include a mounting point 56a, 56b, 56c, 56d, 56e, 56f, and/or 56g.

In other embodiments alternative to mounting the harness 12 to the emergency cot 18 with a plurality of quick release restraint buckles 54a, 54b, 54c, 54d, 54e, 54f, and/or 54g, the harness 12 is mounted to the emergency cot 18 via securely fastening the securing strap segment 58, the pelvis strap 22, the first pair of stabilizing straps 110a and 110b and/or the third pair of stabilizing straps directly to the frame members 59a, 59b of the emergency cot, e.g., via looping and/or interlacing, tightening and/or knotting, binding and/or joining firmly, and tying generally.

In one or more embodiments, referring to FIG. 2, the patient harness system 10 further (optionally) includes an additional pair of stabilizing straps 120a and 120b (hereinafter, “the second pair of stabilizing straps”). Strap length adjusters 126a, 126b may be provided to one and/or both of the second pair of stabilizing straps 120a and 120b. In one or more embodiments, each of the second pair of stabilizing straps, 120a and 120b, includes respective end portions thereof, 122a and 122b, and 122c and 124d. The second pair of stabilizing straps 120a and 120b may be attachable to, attached to, and/or integral with both the chest strap 14 and the pelvis strap 22. More particularly, one end portion 122a and 122c of each of the second pair of stabilizing straps 120a and 120b may be attachable to, attached to, and/or integral with the chest strap 14, and the remaining end portion 122b and 122d of each of the second pair of stabilizing straps 120a and 120b may be attachable to, attached to, and/or integral with the pelvis strap 22. In still further embodiments, the remaining end portion 122b and 122d of each of the second pair of stabilizing straps 120a and 120b is respectively attachable to, attached to, and/or integral with the second and third pelvis strap segments 46 and 48.

In one or more embodiments, each of the second pair of stabilizing straps 120a and 120b may be fixedly attached to the chest strap 14, the second pelvis strap segment 46, and the third pelvis strap segment 48.

In one or more embodiments, referring to FIGS. 2 and 12, the patient harness system 10 (optionally) further includes an additional pair of stabilizing straps 130a and 130b (hereinafter, “the third pair of stabilizing straps”). Each of the third pair of stabilizing straps 130a and 130b may include respective end portions thereof, 134a and 134b, and 134c and 134d. In some embodiments, the third pair of stabilizing straps 130a and 130b are attachable to, attached to, and/or integral with the shoulder harness 20. More particularly, in some embodiments, the third pair of stabilizing straps 130a and 130b are attachable to, attached to, and/or integral with the securing strap 58. In one or more embodiments, each of the third pair of stabilizing straps 130a and 130b may be fixedly attached to the securing strap 58.

In some embodiments, the third pair of stabilizing straps 130a and 130b provides an additional pair of the plurality of quick release restraint buckles, 54g and the remaining buckle (not shown), (i.e., “the fourth pair of quick release restraint buckles”). In further embodiments, one end portion, 134b and 134d, of each of the third pair of stabilizing straps 130a and 130b provides one of the fourth pair of quick release restraint buckles, 54g and the remaining buckle (not shown), respectively. The fourth pair of quick release restraint buckles, 54g and the remaining buckle (not shown), may be as previously described. While not shown, the remaining buckle of the fourth pair of quick release restraint buckles is identical to the buckle 54g, provided on an opposing stabilizing strap 130b. Additionally, each of the fourth pair of quick release restraint buckles, 54g and the remaining buckle (not shown), may include a retaining plug 72, a locking tab 102, and/or a mounting point, as previously described.

In one or more embodiments, the emergency cot 18 provides a pair of mounting points, 56f and 56g, for the third pair of stabilizing straps 130a and 130b (i.e., “the fourth pair of mounting points”). In further embodiments, the fourth pair of mounting points, 56f and 56g, may be respectively for the fourth pair of quick release restraint buckles, 54g and the remaining buckle (not shown). In this embodiment, the third pair of stabilizing straps 130a and 130b mount releasably to the fourth pair of mounting points, 56f and 56g, via the fourth pair of quick release restraint buckles, 54g and the remaining buckle (not shown).

In one or more embodiments, referring to FIGS. 5 and 7, the fourth pair of mounting points, 56f and 56g, are provided on lateral sides of the backrest panel 26 of the emergency cot 18. In other embodiments, the mounting points, 56f and 56g, are located at any place on the cot 18 that is convenient in securing the fourth pair of quick release restraint buckles, 54g and the remaining buckle (not shown), to the cot 18 such that they still provide suitable use with the third pair of stabilizing straps 130a and 130b to the respective mounting points, 56f and 56g. In other embodiments, the mounting points, 56f and 56g, are located at any place on the cot that is convenient in securing the fourth pair of quick release restraint buckles, 54g and the remaining buckle (not shown), to the cot such that they still provide suitable use of the third pair of stabilizing straps 130a and 130b as shown by FIG. 2.

The second and/or third pair of mounting points, 56a and 56b, and/or 56e and the remaining mounting point (not shown), respectively, may be provided in any position and/or order along the side longitudinally extending frame members 59a and 59b, so long as each mounting point of the respective pairs are aligned horizontally and/or vertically along such frame members 59a and 59b (and/or are provided in corresponding positions along the side longitudinally extending frame members 59a and 59b). For example, the second pair of mounting points 56a and 56b may be provided in alignment closest to the backrest panel (relative to the third pair of mounting points 56e and the remaining mounting point (not shown)) and/or the third pair of mounting points may be provided in alignment closest to the backrest panel 26 (relative to the second pair of mounting points 56a and 56b). In alternative embodiments, the second and/or third pair of mounting points, 56a and 56b, and/or 56e and the remaining mounting point (not shown), may be positioned along the side longitudinally extending frame members 59a and 59b such that they are not aligned horizontally or vertically along such frame members 59a and 59b. For example, the second pair of mounting points 56a and 56b may be provided out of alignment closest to the backrest panel (relative to the third pair of mounting points 56e and the remaining mounting point (not shown)) and/or the third pair of mounting points may be provided out of alignment closest to the backrest panel 26 (relative to the second pair of mounting points 56a and 56b).

The first and/or fourth pair of mounting points, 56c and 56d, and/or 56f and 56g, respectively, may be provided in any position and/or order along the lateral sides of the backrest panel 26, so long as each mounting point of the respective pairs are aligned horizontally and/or vertically along such sides (and/or are provided in corresponding positions along the side longitudinally extending frame members 59a and 59b). For example, in some embodiments, the fourth pair of mounting points 56f and 56g may be provided in alignment closest to the seat panel 44 of the cot 18 (relative to the first pair of mounting points 56c and 56d). In one or more embodiments, the fourth pair of mounting points, 56f and 56g, are positioned along the lateral sides of the backrest panel 26 such that they are not aligned horizontally or vertically along such lateral sides. For example, in some embodiments, the fourth pair of mounting points 56f and 56g may be provided out of alignment closest to the seat panel 44 of the cot 18 (relative to the first pair of mounting points 56c and 56d).

In some embodiments, the patient harness system 10 includes the first, second, and third pair of quick release restraint buckles, 54c and 54d, 54a and 54b, and 54e and 54f, respectively. In these embodiments, the plurality of quick release restraint buckles consists of six quick release restraint buckles 54a, 54b, 54c, 54d, 54e, and 54f, and the harness restraint 12 provides a six point connection/attachment/mount to the emergency cot 18. In other embodiments, the patient harness system 10 includes the first, second, third, and fourth pair of quick release restraint buckles, 54c and 54d, 54a and 54b, 54e and 54f, and 54g and the remaining buckle (not shown), respectively. In these embodiments, the plurality of quick release restraint buckles consists of eight quick release restraint buckles 54a, 54b, 54c, 54d, 54e, 54f, 54g and the remaining buckle (not shown). Additionally, in these embodiments, the harness restraint 12 and the chest strap 14 together provide an eight point connection/attachment/mount to the emergency cot 18.

Embodiments of the patient harness system 10 have now been described in detail. Reference will now be made in detail to embodiments of using, attaching, and unattaching restraints and of securing the patient with reference to FIGS. 1-16.

### Guidelines for Using Restraints

In some embodiments, referring to FIG. 3, the harness, chest strap, and thigh strap restraints 12, 14, and 16 are provided to generally secure a patient to an emergency cot 18 and to provide general restraint of the patient during a crash. A patient 24 restrained properly by the patient harness system 10 is shown by FIG. 3.

### Attaching the Chest and Thigh Strap Restraints

Referencing FIGS. 1, 2, 5, and 6, with regard to attaching the chest and thigh strap restraints 14 and 16 to the emergency cot 18, the chest and thigh strap restraints 14 and 16 are attached to the emergency cot 18 by weaving the restraints 14 and 16 through backrest and leg panels 26 and 32, respectively, of the emergency cot 18. With particular regard to attachment of the chest strap restraint 14 to the emergency cot 18, as shown by FIG. 5, the buckle 28 of the unbuckled chest strap restraint 14 may be passed from back to front through a first restraint slot 30a in the backrest panel 26. In this particular embodiment, the backrest panel 26 may be raised. The buckle 28 of the unbuckled chest strap restraint 14 may then be pulled across the top of the backrest panel 26 and through the other restraint slot 30b.

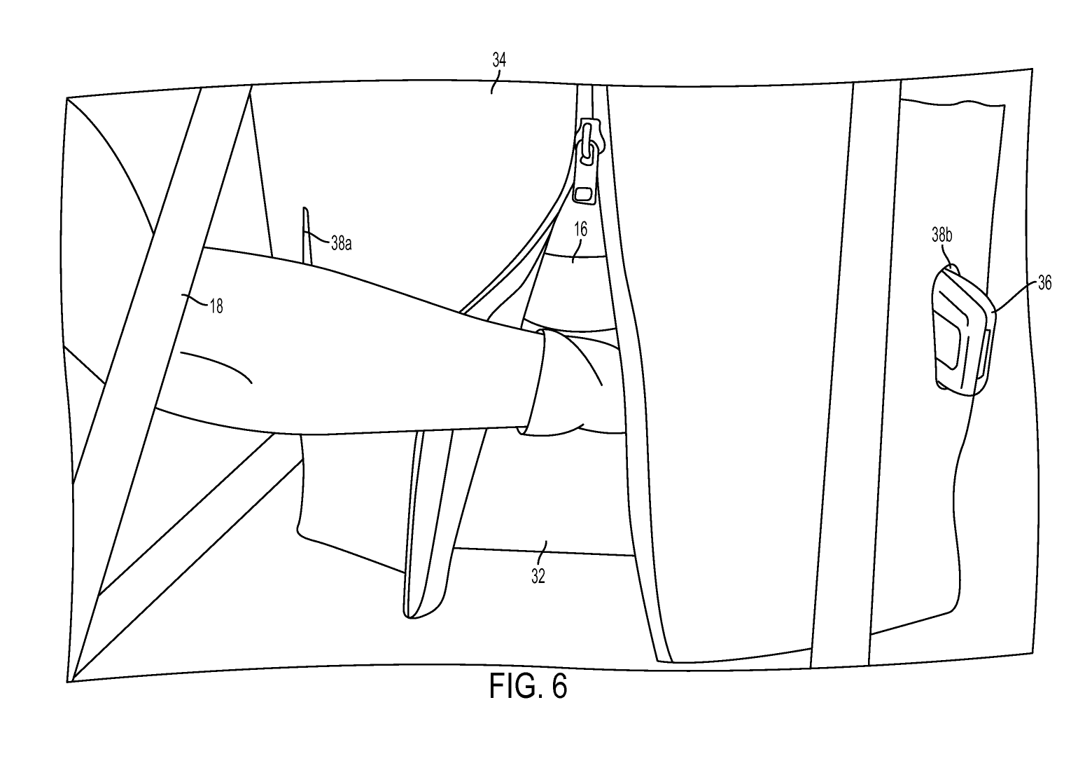

With particular regard to attachment of the thigh strap restraint 16 to the emergency cot 18, for example, with the leg panel 32 of the cot 18 in the highest shock position and a fabric cover 34 (if present) normally provided thereon unzipped, the buckle 36 of the thigh strap restraint 16 may be threaded through a first cover slot 38a (partially shown) in the fabric cover 34, passed under the leg panel 32 of the cot 18 and through a second cover slot 38b on the other side of the fabric cover 34 (as shown by FIG. 6). Once the buckle 36 is passed through the second cover slot 38b, the fabric cover 34 may be zipped. The chest and thigh strap restraints 14 and 16 are thus prepared for use (such as is shown by FIGS. 1-2).

### Attaching the Harness Restraint

Referencing FIGS. 1-2 and 7, in one or more embodiments, the harness restraint 12 is attached to the emergency cot 18 by attaching the pelvis strap 22, the securing strap segment 58, and the first pair of stabilizing straps 110a and 110b thereto. With regard to attaching the pelvis strap 22 to the emergency cot 18, referring to FIG. 7, in one or more embodiments, the first pelvis strap segment 42 is spanned above a seat panel 44 of the cot 18 such that the first pelvis strap segment 42 is located between the seat panel 44 and a mattress 40 (FIG. 1) when the mattress 40 is provided to the cot 18. The second and third pelvis strap segments 46 and 48 may be lengthened via use of the respective strap length adjusters 53a and 53b. By way of example, in one or more embodiments, the second pelvis strap segment 46 may be lengthened by positioning (with the pelvis strap 22 unbuckled) the tang 50 and the second pelvis strap segment 46 perpendicular to the respective strap length adjuster 53a and pulling it away therefrom until the tang 50 is at the desired length. Alternatively, the second pelvis strap segment 46 may be shortened by positioning the loose end of the strap segment 46 perpendicular to the respective strap length adjuster 53a and pulling it away therefrom until the tang 50 is at the desired length. As the strap length adjuster 53b of the third pelvis strap segment 48 (as well as the strap length adjusters 53c and 53d provided to the shoulder harness 20 and the strap length adjusters 114a and 114b, 126a, and 126b, and 132a and 132b, respectively provided to the first, second, and/or third pair of stabilizing straps, as shown in FIG. 2), works in the same manner as the strap length adjuster 53a of the second pelvis strap segment 46, for brevity, no further description of the use of such adjusters is provided.

Referencing FIGS. 5 and 7, each of the second pair of quick release restraint buckles 54a and 54b may then be mounted onto the respective mounting points 56a and 56b provided on the cot 18. More specifically, the second pair of quick release restraint buckles 54a and 54b may be secured to the second pair of mounting points 56a (FIG. 7) and 56b (FIG. 5) by pulling the second pair of quick release restraint buckles 54a and 54b upward to snap fit such buckles 54a and 54b in place. The snap fit employed by the second pair of quick release restraint buckles 54a and 54b, according to the present disclosure, may permit quick releasing of the buckles 54a and 54b without the use of a tool, and is further described in detail with regard to attaching releasably, the shoulder harness 20 to the cot 18, as shown in FIGS. 8-10.

In embodiments wherein the second pair of quick release restraint buckles 54a and 54b include locking tabs 102, such as is shown in FIGS. 14-15, the free end portion 104a of the locking tab 102 may be lifted or otherwise translated away from the outer surface 106 of the buckles 54a, 54b such that the second pair of quick release restraint buckles 54a and 54b may be secured to the second pair of mounting points 56a and 56b. Alternatively, the free end portion 104a of the locking tab 102 may be translated away from the outer surface 106 of the buckles 54a, 54b upon contact of the locking portion 104c of the locking tab 102 with the cap portion 70 of the mounting point 56a, 56b. Additionally, in embodiments wherein the second pair of quick release restraint buckles 54a and 54b include retaining plugs 72, the plug portion 74 of the retaining plug 72 of each of the second pair of quick release restraint buckles 54a and 54b may be fitted securely in the upper slot section 66a of each of the second pair of quick release restraint buckles 54a and 54b.

In embodiments wherein the second pair of quick release restraint buckles 54a and 54b include mounting points 56a and/or 56b, such as is shown in FIG. 16, the second pair of quick release restraint buckles 54a and 54b mount to their respective apertures or slots 142 in mounting structures 140 by lifting or otherwise translating the free end portion 104a of the locking tab 102 away from the outer surface 144 of the mounting structures 140 and/or pulling upwards on each of the quick release restraint buckles to snap fit the stem portion 68 of the mounting points 56a and/or 56b past the detent section 146c of the keyhole shaped aperture or slot 142.

With regard to attaching the shoulder harness 20 to the cot 18, in one or more embodiments, after fitting the mattress 40 (with or without linen) to the cot 18 with the second and third pelvis segments 46 and 48 of the pelvis strap 22 unbuckled as shown, for example, by FIG. 1, the shoulder harness 20 is then fitted by laying the securing strap segment 58 and the shoulder strap segments 60a and 60b thereof on the mattress 40. As both sides of the securing strap segment 58 are the same, only one side is discussed and shown hereafter. More particularly, the first pair of quick release restraint buckles 54c and 54d provided on the securing strap segment 58 may be mounted to the respective first pair of mounting points 56c and 56d provided on the lateral sides of the backrest panel 26 as shown by FIGS. 5 and 8.

In embodiments wherein the first pair of quick release restraint buckles 54c and 54d include locking tabs 102, such as is shown in FIGS. 14-15, the free end portion 104a may be lifted or otherwise translated away from the outer surface 106 of the buckles 54c, 54d, as previously discussed. Additionally, if present, the plug portion 74 of the retaining plug 72 of each of the first pair of quick release restraint buckles 54c and 54d may be fitted securely in the upper slot section 66a of each of the first pair of quick release restraint buckles 54c and 54d.

In embodiments wherein the first pair of quick release restraint buckles 54c and 54d include mounting points 56c and/or 56d, such as is shown in FIG. 16, the first pair of quick release restraint buckles 54c and 54d mount to their respective apertures or slots 142 in mounting structures 140 by lifting or otherwise translating the free end portion 104a of the locking tab 102 away from the outer surface 144 of the mounting structures 140 and/or pulling upwards on each of the quick release restraint buckles to snap fit the stem portion 68 of the mounting points 56c and/or 56d past the detent section 146c of the keyhole shaped aperture or slot 142.

Referring to FIG. 11, with regard to attaching the first pair of stabilizing straps 110a and 110b, in one or more embodiments, after fitting the mattress 40 (with or without linen) to the cot 18 with the second and third pelvis segments 46 and 48, the first pair of stabilizing straps 110a and 110b are be mounted to the emergency cot 18. Each of the first pair of stabilizing straps 110a and 110b may be lengthened and/or shortened as previously described. The third pair of quick release restraint buckles 54e and 54f provided on the first pair of stabilizing straps 110a and 110b may be mounted to the respective third pair of mounting points, 56e and the remaining mounting point (not shown), provided on the side longitudinally extending frame members 59a and 59b adjacent the seat panel 44. The third pair of quick release restraint buckles 54e and 54f may be secured to the respective third pair of mounting points, 56e and the remaining mounting point (not shown), as previously discussed, i.e., by pulling the restraint buckles upward to snap fit such buckles in place.

In embodiments wherein the third pair of quick release restraint buckles 54e and 54f include locking tabs 102, such as is shown in FIGS. 14-15, the free end portion 104a may be lifted or otherwise translated away from the outer surface 106 of the buckles 54e, 54f, as previously discussed. Additionally, if present, the plug portion 74 of the retaining plug 72 of each of the third pair of quick release restraint buckles 54e and 54f may be fitted securely in the upper slot section 66a of each of the third pair of quick release restraint buckles 54e and 54f.

In embodiments wherein the third pair of quick release restraint buckles 54e and 54f include mounting points 56e and/or remaining mounting point, such as is shown in FIG. 16, the third pair of quick release restraint buckles 54e and 54f mount to their respective apertures or slots 142 in mounting structures 140 by lifting or otherwise translating the free end portion 104a of the locking tab 102 away from the outer surface 144 of the mounting structures 140 and/or pulling upwards on each of the quick release restraint buckles to snap fit the stem portion 68 of the mounting points 56e and/or remaining mounting point past the detent section 146c of the keyhole shaped aperture or slot 142.

Referring to FIG. 2, with regard to the second pair of stabilizing straps 120a and 120b, each of the second pair of stabilizing straps 120a and 120b may also be lengthened and/or shortened as previously described.

Referring to FIGS. 2 and 12, with regard to the third pair of stabilizing straps 130a and 130b, in one or more embodiments, (if present) after mounting the first pair of quick release restraint buckles 54c and 54d provided on the securing strap segment 58 to the respective first pair of mounting points 56c and 56d, the third pair of stabilizing straps 130a and 130b may be mounted to the emergency cot 18. The fourth pair of quick release restraint buckles, 54g and the remaining buckle (not shown), provided on the third pair of stabilizing straps 130a and 130b may be mounted to the respective fourth pair of mounting points, 56f and the remaining mounting point (not shown), provided on the lateral sides of the backrest panel 26. The fourth pair of quick release restraint buckles, 54g and the remaining buckle (not shown), may be secured to the respective fourth pair of mounting points, 56f and the remaining mounting point (not shown) as previously discussed, i.e., by pulling the restraint buckles upward to snap fit such buckles in place.

In embodiments wherein the fourth pair of quick release restraint buckles 54g and remaining buckle (not shown) include locking tabs 102, such as is shown in FIGS. 14-15, the free end portion 104a may be lifted or otherwise translated away from the outer surface 106 of the buckles 54g and remaining buckle (not shown) as previously discussed. If present, the plug portion 74 of the retaining plug 72 of each of the fourth pair of quick release restraint buckles, 54g and the remaining buckle (not shown), may be fitted securely in the upper slot section 66a of each of the fourth pair of quick release restraint buckles 54g and the remaining buckle (not shown).

In embodiments wherein the fourth pair of quick release restraint buckles 54g and remaining buckle (not shown) include mounting points 56f and/or remaining mounting point, such as is shown in FIG. 16, the fourth pair of quick release restraint buckles 54g and remaining buckle (not shown) mount to their respective apertures or slots 142 in mounting structures 140 by lifting or otherwise translating the free end portion 104a of the locking tab 102 away from the outer surface 144 of the mounting structures 140 and/or pulling upwards on each of the quick release restraint buckles to snap fit the stem portion 68 of the mounting points 56f and/or remaining mounting point past the detent section 146c of the keyhole shaped aperture or slot 142.

Securing the Patient with the Restraints

To secure the patient 24 to the emergency cot 18 with the patient harness system 10, the shoulder strap segments 60a and 60b, pelvis strap segments 46 and 48, the first pair of stabilizing straps 110a and 110b, and/or the second pair of stabilizing straps 120a and 120b may be lengthened and/or shortened to accommodate the patient. The harness system 10 may also be unbuckled and arranged ready for fitment as shown by FIGS. 1 and 13. Once the patient 24 has been transferred to the cot 18 using approved EMS-procedures, the shoulder strap segments 60a and 60b may be pulled over the shoulders of the patient 24 and to the front of the patient 24 as shown by FIG. 13. A pair of tangs, 76a and 76b, provided at the respective end portions of the shoulder strap segments 60a and 60b may be positioned adjacent each other.

After passing the tang 50 of the pelvis strap 22 through the apertures or slots 78a and 78b and being seated securely in the engagement slot 80 of the buckle 52, the tangs, 76a and 76b, may be in contact with each other and remain as such until as long as the pelvis strap 22 is buckled. In embodiments wherein the tangs, 76a and 76b, are twisted, opposed faces, 84a and 84b, of the twisted tangs may be in contact with each other and remain as such until as long as the pelvis strap 22 is buckled as shown by FIG. 3. Next, the shoulder strap segments 60a and 60b may be adjusted until they are snug against the patient's shoulders and the two tangs 76a and 76b are centrally positioned on the patient's torso as shown by FIG. 3 for adults (14 years and older or 46 KG or over) or centrally positioned on the boney area of the pelvis for children (3-14 years and 14-46 KG). The first and/or second pair of stabilizing straps, 110a and 110b and/or 120a and 120b may also be lengthened and/or shortened until they are snug against the patient's stomach and/or pelvic area. Finally, the chest and thigh strap restraints 14 and 16 may be fitted and secured over the chest and thigh of the patient 24 and adjusted as also shown by FIG. 3.

### Unfastening the Harness

The harness has been designed to make it easier to transfer patients. If the bedding is to be used in transferring the patient, the shoulder harness 20 may be removed but the other straps may be left attached to the cot 18. To do so, the chest, pelvis and thigh strap restraints 14, 22, and 16, respectively, may be unfastened and placed in a suitable position out of the way. The shoulder strap segments 60a and 60b may be pulled over the patient's head and positioned clear of the patient. The second pair of stabilizing straps 120a and 120b may be lengthened and/or shortened. If present, the retaining plug 72 on one of the backrest quick release restraint buckles 54c may be removed, for example as shown by FIGS. 8-9 and 12. The quick release restraint buckle 54c may be pushed down and unclipped from the mounting point 56c as shown by FIGS. 8 and 12. Alternatively, if present, the free end portion 104a of the locking tab 102 may be lifted or otherwise translated away from the outer surface 106 of the quick release restraint buckle 54c or the outer surface 144 of the mounting structures 140, such that the quick release restraint buckle 54 may be pushed down and unclipped therefrom. The shoulder harness 20 may be pulled up towards the patient's head and the securing strap segment 58 may be carefully slid out from under the patient 24 until the shoulder harness 20 is cleared from the mattress 40. In this manner, the patient 24 positioned on the mattress 40 may be transferred from the cot 18.

It should now be understood that various aspects of the present disclosure are described herein and that such aspects may be utilized in conjunction with various other aspects:

In a first aspect, a patient harness system for an emergency cot is disclosed. The patient harness system includes a chest strap restraint, a thigh strap restraint, and a harness restraint including a shoulder harness, a pelvis strap attachable to the shoulder harness, and a first pair of stabilizing straps attached to the pelvis strap. The harness restraint is mountable to the emergency cot via a plurality of quick release restraint buckles. Each of the plurality of quick release restraint buckles includes a mounting point or a slot, wherein the mounting point includes a stem portion attached to a cap portion, wherein the slot includes an upper slot section, a lower slot section, and a pair of detents, wherein the upper slot section and the lower slot section are separated by the pair of detents, wherein the upper slot section tapers to the pair of detents, and wherein the pair of detents are sized to snap fit a mounting point provided to the emergency cot from the upper slot section to the lower slot section. The shoulder harness includes a pair of shoulder strap segments attached to a securing strap segment, wherein the securing strap segment includes a first pair of the plurality of quick release restraint buckles. The pelvis strap includes a second pair of the plurality of quick release restraint buckles. The first pair of stabilizing straps includes a third pair of the plurality of quick release restraint buckles.

In a second aspect, a patient harness system according to the first aspect is disclosed, wherein each of the plurality of quick release restraint buckles includes the slot, and wherein the emergency cot provides a plurality of mounting points for the plurality of quick release restraint buckles, such that each of the securing strap segment, the pelvis strap, and the first pair of stabilizing straps mount releasably to the plurality of mounting points via the first, second, and third pair of the plurality of quick release restraint buckles.

In a third aspect, a patient harness system according to the first or the second aspects is disclosed, wherein each of the plurality of quick release restraint buckles includes the slot, and wherein the emergency cot provides a first, second, and third pair of mounting points respectively for the first, second, and third pair of the plurality of quick release restraint buckles, such that each of the securing strap segment, the pelvis strap, and the first pair of stabilizing straps mount releasably to the first, second and third pair of mounting points via the first, second, and third pair of the plurality of quick release restraint buckles.

In a fourth aspect, a patient harness system according to the first to the third aspects is disclosed, further including a second pair of stabilizing straps attached to the chest strap restraint and to the pelvis strap.

In a fifth aspect, a patient harness system according to the first to the fourth aspects is disclosed, further including a second pair of stabilizing straps attached to both the chest strap restraint and to the pelvis strap, wherein: each of the second pair of stabilizing straps includes a first end portion and a second end portion, the first end portion of each of the second pair of stabilizing straps is attached to the chest strap restraint, and the second end portion of each of the second pair of stabilizing straps is attached to the pelvis strap.

In a sixth aspect, a patient harness system according to the first to the fifth aspects is disclosed, further including a second pair of stabilizing straps attached to both the chest strap restraint and to the pelvis strap, wherein: each of the second pair of stabilizing straps includes a first end portion and a second end portion, the first end portion of each of the second pair of stabilizing straps is attached to the chest strap restraint, and the second end portion of each of the second pair of stabilizing straps is respectively attached to a second pelvis strap segment or a third pelvis strap segment of the pelvis strap.

In a seventh aspect, a patient harness system according to the first to the sixth aspects is disclosed, further including a third pair of stabilizing straps attached to the securing strap segment, wherein the third pair of stabilizing straps includes a fourth pair of the plurality of quick release restraint buckles.

In an eighth aspect, a patient harness system according to the seventh aspect is disclosed, wherein each of the plurality of quick release restraint buckles includes the slot, and wherein the emergency cot provides a plurality of mounting points for the plurality of quick release restraint buckles, such that each of the securing strap segment, the pelvis strap, the first pair of stabilizing straps, and the third pair of stabilizing straps mount releasably to the plurality of mounting points via the first, second, third, and fourth pair of the plurality of quick release restraint buckles.

In a ninth aspect, a patient harness system according to the first to the eighth aspects is disclosed, further including a second pair of stabilizing straps attached to both the chest strap restraint and to the pelvis strap, and a third pair of stabilizing straps attached to the securing strap segment, wherein the third pair of stabilizing straps includes a fourth pair of the plurality of quick release restraint buckles.

In a tenth aspect, a patient harness system according to the ninth aspect is disclosed, wherein each of the second pair of stabilizing straps includes a first end portion and a second end portion, the first end portion of each of the second pair of stabilizing straps is attached to the chest strap restraint, the second end portion of each of the second pair of stabilizing straps is attached to the pelvis strap, each of the plurality of quick release restraint buckles includes the slot, and the emergency cot provides a plurality of mounting points for the plurality of quick release restraint buckles, such that each of the securing strap segment, the pelvis strap, the first pair of stabilizing straps, and the third pair of stabilizing straps mount releasably to the plurality of mounting points via the first, second, third, and fourth pair of the plurality of quick release restraint buckles.

In an eleventh aspect, a patient harness system according to the first to the tenth aspects is disclosed, wherein the plurality of quick release restraint buckles includes six quick release restraint buckles.

In a twelfth aspect, a patient harness system according to the first to the eleventh aspects is disclosed, further including a third pair of stabilizing straps attached to the chest strap restraint, wherein the third pair of stabilizing straps includes a fourth pair of the plurality of quick release restraint buckles, and wherein the plurality of quick release restraint buckles includes eight quick release restraint buckles.

In a thirteenth aspect, a patient harness system according to the first to the twelfth aspects is disclosed, wherein the pair of shoulder strap segments provides a pair of tangs.

In a fourteenth aspect, a patient harness system according to the first to the thirteenth aspects is disclosed, wherein the pair of shoulder strap segments provides a pair of tangs each with a slot, and the pelvis strap provides a buckle and a tang, the tang being sized to fit through each slot of the tangs when secured to the buckle, such that the pelvis strap is attached to the shoulder harness when the tangs are secured to the buckle of the pelvis strap.

In a fifteenth aspect, a patient harness system according to the first to the fourteenth aspects is disclosed, wherein the pelvis strap provides a buckle and a tang, and the pair of shoulder strap segments provides a pair of tangs each with a slot, the slot being sized to permit the tang of the pelvis strap to fit therethrough and to be seated releasably in a slot of the buckle of the pelvis strap.

In a sixteenth aspect, a patient harness system according to the first to the fifteenth aspects is disclosed, wherein the pelvis strap provides a buckle and a tang, the pair of shoulder strap segments provides a pair of elongate twisted tangs each with a slot, the slot being sized to permit the tang of the pelvis strap to fit therethrough and to be seated releasably in a slot of the buckle of the pelvis strap, and after passing the tang of the pelvis strap through each slot of the elongate twisted tangs and being seated in the slot of the buckle of the pelvis strap, opposed faces of the pair of elongate twisted tangs are in contact with each other.

In a seventeenth aspect, a patient harness system according to the first to the sixteenth aspects is disclosed, wherein the emergency cot is fitted with a mattress, the pelvis strap has a first pelvis strap segment, a second pelvis strap segment, and a third pelvis strap segment, the first pelvis strap segment is located between a seat panel of the emergency cot and the mattress, the second pelvis strap segment provides a tang, and the third pelvis strap segment provides a buckle, the pair of shoulder strap segments provides a pair of tangs, wherein each of the pair of tangs provides a slot sized to permit the tang of the second pelvis strap segment to fit therethrough and to be seated releasably in a slot of the buckle of the third pelvis strap segment.

In an eighteenth aspect, a patient harness system according to the seventeenth aspect is disclosed, wherein one of the first pair of stabilizing straps is attached to the second pelvis strap segment and the remaining one of the first pair of stabilizing straps is attached to the third pelvis strap segment.

In a nineteenth aspect, a patient harness system according to the first to the eighteenth aspects is disclosed, wherein each of the plurality of quick release restraint buckles includes the slot, wherein the harness restraint provides a retaining plug for each of the plurality of quick release restraint buckles, and wherein the retaining plug has a plug portion sized and shaped to fit securely in the upper slot section.

In a twentieth aspect, a patient harness system according to the first to the eighteenth aspects is disclosed, wherein each of the plurality of quick release restraint buckles includes the slot, and wherein the harness restraint provides a locking tab attached to each of the plurality of quick release restraint buckles.

In a twenty-first aspect, a patient harness system according to the twentieth aspect is disclosed, wherein the locking tab includes an attachment end portion, a free end portion, and a locking portion, wherein the attachment end portion is attached to each of the plurality of quick release restraint buckles, and wherein the locking tab extends across the upper slot section.

In a twenty-second aspect, a patient harness system according to the first to the twenty-first aspect is disclosed, wherein each of the plurality of quick release restraint buckles includes the slot, wherein the harness restraint provides a locking tab attached to each of the plurality of quick release restraint buckles, and wherein the locking tab is biased toward a locking position thereof.

In a twenty-third aspect, a patient harness system according to the first aspect is disclosed, wherein each of the plurality of quick release restraint buckles includes the mounting point, the emergency cot provides a plurality of mounting structures for the plurality of quick release restraint buckles, wherein each of the plurality of mounting structures includes an upper slot section, a lower slot section, a pair of detents, and a locking tab, wherein the upper slot section and the lower slot section are separated by the pair of detents, wherein the upper slot section tapers to the pair of detents, wherein the pair of detents are sized to snap fit a mounting point provided to the plurality of quick release restraint buckles from the upper slot section to the lower slot section, and wherein the locking tab extends across the upper slot section, such that each of the securing strap segment, the pelvis strap, the first pair of stabilizing straps, and the third pair of stabilizing straps mount releasably to the plurality of mounting structures via the first, second, third, and fourth pair of the plurality of quick release restraint buckles.

In a twenty-fourth aspect, a patient harness system according to the twenty-third aspect is disclosed, wherein the locking tab is biased toward a locking position thereof.

In a twenty-fifth aspect, a patient harness system according to the first to the twenty-second aspects is disclosed, wherein the detent section is sized to snap fit a mounting point provided to the emergency cot from the upper slot section to the lower slot section.

In a twenty-sixth aspect, a patient harness system is disclosed. The patient harness system includes a chest strap restraint, a thigh strap restraint, and a harness restraint including a shoulder harness, a pelvis strap attachable to the shoulder harness, and a first pair of stabilizing straps attached to the pelvis strap, the harness restraint being mountable to the emergency cot via a plurality of quick release restraint buckles. Each of the plurality of quick release restraint buckles includes a mounting point or a slot, wherein the mounting point includes a stem portion attached to a cap portion, wherein the slot includes an upper slot section, a lower slot section, and a pair of detents, wherein the upper slot section and the lower slot section are separated by the pair of detents, wherein the upper slot section tapers to the pair of detents, and wherein the pair of detents are sized to snap fit a mounting point provided to the emergency cot from the upper slot section to the lower slot section. The shoulder harness includes a pair of shoulder strap segments attached to a securing strap segment, wherein the securing strap segment includes a first pair of the plurality of quick release restraint buckles, and wherein the pair of shoulder strap segments provides a pair of elongate tangs each with a slot. The pelvis strap provides a buckle and a tang, the tang being sized to fit through each slot of the elongate tangs when secured to the buckle, such that the pelvis strap is attached to the shoulder harness when the elongate tangs are secured to the buckle of the pelvis strap. The pelvis strap includes a second pair of the plurality of quick release restraint buckles. The first pair of stabilizing straps includes a third pair of the plurality of quick release restraint buckles.

In a twenty-seventh aspect, a method of securing a patient to the emergency cot using the patient harness system according to the first to the twenty-sixth aspects is disclosed, the method including: securing the chest strap restraint to the emergency cot, securing the thigh strap restraint to the emergency cot, and mounting the harness restraint to the emergency cot via the first, the second, and the third pair of the plurality of quick release restraint buckles.

In a twenty-eighth aspect, a method of securing a patient according to the twenty-seventh aspect is disclosed, wherein mounting the harness restraint includes snap fitting the first, second, and third pair of the plurality of quick release restraint buckles to mounting points provided on a backrest panel and longitudinally extending frame members thereof.

In a twenty-ninth aspect, a method of securing a patient according to the twenty-eighth aspect is disclosed, further including installing a retaining plug in each of the first, second, and third pair of the plurality of quick release restraint buckles.

In a thirtieth aspect, a method of securing a patient according to the twenty-seventh aspect is disclosed, wherein mounting the harness restraint includes snap fitting the first, second, and third pair of the plurality of quick release restraint buckles to mounting structures provided on a backrest panel and longitudinally extending frame members thereof.

In a thirty-first aspect, a method of securing a patient according to the twenty-seventh to the thirtieth aspects is disclosed, wherein the pair of shoulder strap segments provides a pair of tangs each with a slot, and wherein the pelvis strap provides a buckle and a tang, the tang being sized to fit through each slot of the tangs when secured to the buckle, the method further including placing the patient on the emergency cot, placing the shoulder strap segments over the patient, and securing to the buckle the tang of the pelvis strap fitted through each slot of the tangs.

In a thirty-second aspect, a method of securing a patient according to the twenty-seventh to the thirty-first aspects is disclosed, further including further securing the patient to the emergency cot via the chest and the thigh strap restraints.

It is noted that terms like “preferably,” “generally,” “commonly,” and “typically” are not utilized herein to limit the scope of the claims or to imply that certain features are critical, essential, or even important to the structure or function of the claims. Rather, these terms are merely intended to highlight alternative or additional features that may or may not be utilized in a particular embodiment of the present disclosure.

For the purposes of describing and defining the present disclosure it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

All documents cited are incorporated herein by reference; the citation of any document is not to be construed as an admission that it is prior art with respect to the present disclosure.

It is to be further understood that where descriptions of various embodiments use the term “comprising,” and/or “including” those skilled in the art would understand that in some specific instances, an embodiment can be alternatively described using language “consisting essentially of” or “consisting of.”

While particular embodiments of the present disclosure have been illustrated and described, it would be obvious to one skilled in the art that various other changes and modifications can be made without departing from the spirit and scope of the disclosure. It is therefore intended to cover in the appended claims all such changes and modifications that are within the scope of this disclosure.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

1. A patient harness system for an emergency cot comprising:
a chest strap restraint;
a thigh strap restraint; and
a harness restraint comprising a shoulder harness, a pelvis strap attachable to the shoulder harness, and a first pair of stabilizing straps attached to the pelvis strap, the harness restraint being mountable to the emergency cot via a plurality of quick release restraint buckles, wherein:
each of the plurality of quick release restraint buckles comprises a mounting point or a slot, wherein the mounting point includes a stem portion attached to a cap portion, wherein the slot includes an upper slot section, a lower slot section, and a pair of detents, wherein the upper slot section and the lower slot section are separated by the pair of detents, and wherein the upper slot section tapers to the pair of detents,
the shoulder harness comprises a pair of shoulder strap segments attached to a securing strap segment, wherein the securing strap segment comprises a first pair of the plurality of quick release restraint buckles,
the pelvis strap comprises a second pair of the plurality of quick release restraint buckles, and
the first pair of stabilizing straps comprises a third pair of the plurality of quick release restraint buckles.

2. The patient harness system of claim 1, wherein each of the plurality of quick release restraint buckles comprises the slot, wherein the emergency cot provides a plurality of mounting points for the plurality of quick release restraint buckles, and wherein the pair of detents is sized to snap fit one of the plurality of mounting points provided by the emergency cot from the upper slot section to the lower slot section such that each of the securing strap segment, the pelvis strap, and the first pair of stabilizing straps mount releasably to the plurality of mounting points via the first, second, and third pair of the plurality of quick release restraint buckles.

3. (canceled)

4. The patient harness system of claim 1, further comprising a second pair of stabilizing straps attached to the chest strap restraint and to the pelvis strap.

5. The patient harness system of claim 1, further comprising a second pair of stabilizing straps attached to both the chest strap restraint and to the pelvis strap, wherein:
each of the second pair of stabilizing straps comprises a first end portion and a second end portion,
the first end portion of each of the second pair of stabilizing straps is attached to the chest strap restraint, and
the second end portion of each of the second pair of stabilizing straps is attached to the pelvis strap.

6. The patient harness system of claim 1, further comprising a second pair of stabilizing straps attached to both the chest strap restraint and to the pelvis strap, wherein:
each of the second pair of stabilizing straps comprises a first end portion and a second end portion,
the first end portion of each of the second pair of stabilizing straps is attached to the chest strap restraint, and
the second end portion of each of the second pair of stabilizing straps is respectively attached to a second pelvis strap segment or a third pelvis strap segment of the pelvis strap.

7. The patient harness system of claim 1, further comprising a third pair of stabilizing straps attached to the securing strap segment, wherein the third pair of stabilizing straps comprises a fourth pair of the plurality of quick release restraint buckles.

8. (canceled)

9. The patient harness system of claim 1, further comprising:
a second pair of stabilizing straps attached to both the chest strap restraint and to the pelvis strap, and
a third pair of stabilizing straps attached to the securing strap segment, wherein the third pair of stabilizing straps comprises a fourth pair of the plurality of quick release restraint buckles.

10. The patient harness system of claim 9, wherein:
each of the second pair of stabilizing straps comprises a first end portion and a second end portion,
the first end portion of each of the second pair of stabilizing straps is attached to the chest strap restraint,
the second end portion of each of the second pair of stabilizing straps is attached to the pelvis strap,
each of the plurality of quick release restraint buckles comprises the slot,
the emergency cot provides a plurality of mounting points for the plurality of quick release restraint buckles, such that each of the securing strap segment, and
the pair of detents is sized to snap fit one of the plurality of mounting points provided by the emergency cot from the upper slot section to the lower slot section such that the pelvis strap, the first pair of stabilizing straps, and the third pair of stabilizing straps mount releasably to the plurality of mounting points via the first, second, third, and fourth pair of the plurality of quick release restraint buckles.

11. (canceled)

12. The patient harness system of claim 1, further comprising a third pair of stabilizing straps attached to the chest strap restraint, wherein the third pair of stabilizing straps comprises a fourth pair of the plurality of quick release restraint buckles, and wherein the plurality of quick release restraint buckles consists of eight quick release restraint buckles.

13. The patient harness system of claim 1, wherein the pair of shoulder strap segments provides a pair of tangs.

14. The patient harness system of claim 1, wherein:
the pair of shoulder strap segments provides a pair of tangs each with a slot, and
the pelvis strap provides a buckle and a tang, the tang being sized to fit through each slot of the tangs when secured to the buckle, such that the pelvis strap is attached to the shoulder harness when the tangs are secured to the buckle of the pelvis strap.

15. The patient harness system of claim 1, wherein:
the pelvis strap provides a buckle and a tang, and
the pair of shoulder strap segments provides a pair of tangs each with a slot, the slot being sized to permit the tang of the pelvis strap to fit therethrough and to be seated releasably in a slot of the buckle of the pelvis strap.

16. The patient harness system of claim 1, wherein:
the pelvis strap provides a buckle and a tang,
the pair of shoulder strap segments provides a pair of elongate twisted tangs each with a slot, the slot being sized to permit the tang of the pelvis strap to fit therethrough and to be seated releasably in a slot of the buckle of the pelvis strap, and
after passing the tang of the pelvis strap through each slot of the elongate twisted tangs and being seated in the slot of the buckle of the pelvis strap, opposed faces of the pair of elongate twisted tangs are in contact with each other.

17. (canceled)

18. The patient harness system of claim 17, wherein one of the first pair of stabilizing straps is attached to the second pelvis strap segment and the remaining one of the first pair of stabilizing straps is attached to the third pelvis strap segment.

19. The patient harness system of claim 1, wherein each of the plurality of quick release restraint buckles comprises the slot, wherein the harness restraint provides a retaining plug for each of the plurality of quick release restraint buckles, and wherein the retaining plug has a plug portion sized and shaped to fit securely in the upper slot section.

20. The patient harness system of claim 1, wherein each of the plurality of quick release restraint buckles comprises the slot, and wherein the harness restraint provides a locking tab attached to each of the plurality of quick release restraint buckles.

21. The patient harness system of claim 20, wherein the locking tab includes an attachment end portion, a free end portion, and a locking portion, wherein the attachment end portion is attached to each of the plurality of quick release restraint buckles, and wherein the locking tab extends across the upper slot section.

22. The patient harness system of claim 1, wherein each of the plurality of quick release restraint buckles comprises the slot, wherein the harness restraint provides a locking tab attached to each of the plurality of quick release restraint buckles, and wherein the locking tab is biased toward a locking position thereof.

23. The patient harness system of claim 1, wherein:
each of the plurality of quick release restraint buckles comprises the mounting point,
the emergency cot provides a plurality of mounting structures for the plurality of quick release restraint buckles, wherein each of the plurality of mounting structures includes an upper slot section, a lower slot section, a pair of detents, and a locking tab, wherein the upper slot section and the lower slot section are separated by the pair of detents, wherein the upper slot section tapers to the pair of detents, wherein the pair of detents are sized to snap fit a mounting point provided to the plurality of quick release restraint buckles from the upper slot section to the lower slot section, and wherein the locking tab extends across the upper slot section, such that each of the securing strap segment, the pelvis strap, the first pair of stabilizing straps, and the third pair of stabilizing straps mount releasably to the plurality of mounting structures via the first, second, third, and fourth pair of the plurality of quick release restraint buckles.

24. The patient harness system of claim 23, wherein the locking tab is biased toward a locking position thereof.

25.-26. (canceled)

27. A method of securing a patient to the emergency cot using the patient harness system according to claim 1, the method comprising:
securing the chest strap restraint to the emergency cot;
securing the thigh strap restraint to the emergency cot; and
mounting the harness restraint to the emergency cot via the first, the second, and the third pair of the plurality of quick release restraint buckles.

28.-32. (canceled)
